(19) United States
(12) Patent Application Publication
(10) Pub. No.: US 2014/0302223 A1
(43) Pub. Date: Oct. 9, 2014

(54) NUTRITIONAL COMPOSITIONS COMPRISING A SOLUBLE VISCOUS FIBER AND A POLYPHENOL-CONTAINING PLANT EXTRACT

(71) Applicants: Mary-Beth Skelding, Pataskala, OH (US); Neile K. Edens, Columbus, OH (US); Vikkie A. Mustad, Galena, OH (US)

(72) Inventors: Mary-Beth Skelding, Pataskala, OH (US); Neile K. Edens, Columbus, OH (US); Vikkie A. Mustad, Galena, OH (US)

(73) Assignee: ABBOTT LABORATORIES, Abbott Park, IL (US)

(21) Appl. No.: 14/237,527

(22) PCT Filed: Aug. 16, 2011
(86) PCT No.: PCT/US2011/047890

§ 371 Date: Jun. 25, 2014

(51) Int. Cl. A23L 1/29; A23L 1/308

(52) U.S. Cl. CPC A23L 1/296; A23L 1/3082
USPC 426/648

(57) ABSTRACT

Disclosed are nutritional compositions comprising a soluble viscous fiber and a polyphenol-containing plant extract. The viscosity of the nutritional compositions may be adjusted and controlled without varying the concentration of the soluble viscous fiber in the composition by including the polyphenol-containing plant extract.

### TECHNICAL FIELD

The present disclosure relates to nutritional compositions comprising a soluble viscous fiber and a polyphenol-containing plant extract. The soluble viscous fiber may be part of an induced viscosity fiber (IVF) system further including a soluble carbohydrate. The viscosity of the nutritional composition can be altered and controlled by the addition of a polyphenol-containing plant extract, by the addition of a polyphenol-containing plant extract and the freezing and thawing of the resulting solution, or by the addition of a polyphenol-containing plant extract solution that has been frozen and thawed before being added to the soluble viscous fiber.

### BACKGROUND OF THE DISCLOSURE

Diabetes mellitus is a disorder of carbohydrate metabolism resulting from insufficient production of, or reduced sensitivity to, insulin. In persons who have diabetes, the normal ability of the body to utilize glucose is compromised, thereby increasing blood glucose levels. As more glucose accumulates in the blood, excess levels of glucose are excreted in the urine. Corresponding symptoms of diabetes include increased urinary volume and frequency, thirst, hunger, weight loss, and weakness.

Diabetes is often characterized as either type 1 or type 2. Among the earliest manifestations of type 2 diabetes includes excessive blood glucose levels following a meal due to inadequate first phase insulin secretion. In these individuals, the response to increased blood glucose levels and the modulation of such levels that would otherwise occur in a healthy individual is reduced or absent and thus results in an excessive spike in postprandial blood glucose levels. This is particularly significant given the well established correlation between effective blood glucose control in a diabetic individual and the risk of developing cardiovascular or circulatory diseases or disorders, especially the microvascular and macrovascular complications from such diseases or disorders. As such, controlling postprandial blood glucose levels in the diabetic individual is an important step in reducing the development of cardiovascular or circulatory diseases, and of course the subsequent development of cardiovascular related conditions such as retinopathy, neuropathy, nephropathy, and so forth.

Postprandial glucose levels may be controlled and regulated in prediabetic individuals and individuals with diabetes, and particularly type 2 diabetes, by administering to the individual a nutritional composition comprising a soluble viscous fiber, which has been shown to blunt the glycemic response to a meal while addressing the negative organoleptic, tolerance and physical stability associated with other fibers. Many times, the advantages of the soluble viscous fiber can be utilized in combination with a soluble carbohydrate, which may prevent the complete dissolution of the soluble fiber in the liquid. Upon ingestion of the soluble viscous fiber and soluble carbohydrate, however, alpha-amylase hydrolyzes the starch enabling the fiber to solubilize and form a viscous digesta.

While nutritional compositions comprising a soluble viscous fiber, and optionally a soluble carbohydrate may reduce post-prandial glucose levels upon ingestion, it has been found that in some instances the viscosity of liquid including soluble viscous fibers and soluble carbohydrate may be difficult to control and manipulate, and may result in compositions that are unpleasing in thickness and palatability to consumers. Previously, this problem has been addressed by adjusting the concentration of the soluble viscous fibers in the compositions. While this allows the viscosity to be adjusted in the nutritional composition, the health effects provided by the composition, e.g., controlling the postprandial glucose levels, may be compromised.

There is therefore a need for nutritional liquids including soluble viscous fibers alone or in combination with a soluble carbohydrate that have desirable viscosities while still providing effective and targeted nutrition, including postprandial blood glucose level control, as well as methods of adjusting and controlling the viscosity of nutritional compositions including soluble viscous fibers and soluble carbohydrates.

### SUMMARY OF THE DISCLOSURE

One embodiment is directed to a nutritional composition comprising a soluble viscous fiber and a plant extract having a polyphenol content of at least about 10% by weight.

Another embodiment is directed to a nutritional composition comprising an induced viscosity fiber system and a plant extract having a polyphenol content of at least about 10% by weight. The induced viscosity fiber system comprises a soluble viscous fiber and a soluble carbohydrate.

Another embodiment is directed to a method of controlling the viscosity of a liquid nutritional composition comprising a soluble viscous fiber. The method comprises combining a plant extract having a polyphenol content of at least about 10% by weight with the soluble viscosity fiber in a liquid solution, freezing the liquid solution, and thawing the liquid solution to room temperature.

The viscosity of a liquid nutritional composition including a soluble viscous fiber component and optionally a soluble carbohydrate component can be controlled and adjusted, without necessarily adjusting the concentration of soluble viscous fiber, through the addition of a polyphenol-containing plant extract to the liquid nutritional composition. When the liquid nutritional composition is prepared at room temperature, adding a polyphenol-containing plant extract to the liquid thickens the solution significantly, including up to five times the viscosity as compared to the liquid without the extract. The extract can be used to adjust and control viscosity so as to make a product that is satisfactory to consumers.

Accordingly, the liquid nutritional compositions and methods of the present disclosure provide liquid nutritional compositions that are of a desirable viscosity and palatable and may, in some embodiments, be able to offer a natural therapeutic option that may contribute to the maintenance of optimal glycemic control in subjects that are prediabetic, have impaired glucose tolerance, or have type 2 diabetes. These benefits are advantageously achieved in such individuals without experiencing many of the complications often associated with the administration of oral anti-diabetic medications.

### BRIEF DESCRIPTION OF THE DRAWINGS

FIG. 1 is a graph depicting the viscosities of a composition of induced viscosity fiber (IVF) and a composition of induced viscosity fiber with Salacia oblonga extract (IVFSOE), both of which were prepared at room temperature, as discussed in Example 3.

FIG. 2 is a graph depicting the viscosities of a composition of induced viscosity fiber (IVF) and a composition of induced viscosity fiber with Salacia oblonga (IVFSOE), both of which were frozen and thawed before being analyzed, as discussed in Example 4.

FIG. 3 is a graph depicting the viscosities of a composition of induced viscosity fiber solubilized with water (IVF) and a composition of induced viscosity fiber solubilized with a solution of Salacia oblonga extract that has been frozen and thawed (IVFSOE), as discussed in Example 5.

FIG. 4 is a graph depicting the viscosities of a composition of guar gum solubilized with water (Guar) and a composition of guar gum and Salacia oblonga extract that has been frozen and thawed (GuarSOE), as discussed in Example 6.

### DETAILED DESCRIPTION OF THE DISCLOSURE

The various embodiments herein may include liquid nutritional compositions including a soluble viscous fiber and, optionally, a soluble carbohydrate, in combination with a polyphenol-containing plant extract, methods of adjusting and/or controlling the viscosity of those compositions, and methods of using those compositions. These and other essential or optional elements of the various embodiments are described in detail hereinafter.

The term “nutritional composition” as used herein, unless otherwise specified, refers to a composition suitable for oral administration to an individual but which does not provide sufficient fat, protein and carbohydrate to form a sole or primary source of nutrition in the individual.

The term “meal” as used herein refers to a typical selection of food to be consumed by an individual in one sitting, which most typically includes the food consumed at a breakfast, a lunch, or a dinner and which includes a combination of fat, protein, carbohydrates, vitamins, minerals and water typical of such consumption in one sitting, although it is understood that the term “meal” may also include smaller quantities or even less balanced food combinations taken in the form of snacks between breakfast, lunch and or dinner.

The term “soluble viscous fiber” as used herein, unless otherwise specified, refers to fiber that can be at least partially dissolved in water and generally carries little to no charge at neutral pH.

The term “soluble carbohydrate” as used herein, unless otherwise specified, refers to carbohydrates, including starches and lightly hydrolyzed starches, that are at least partially dissolvable in water.

The term “starch” as used herein, unless otherwise specified, refers to the variety of cereal and root starches that contain a mixture of amylase and amylopectin starch molecules.

The term “lightly hydrolyzed starch” as used herein, unless otherwise specified, refers to a product obtained by acid, enzyme or combined hydrolysis of starch consisting of lower molecular weight polysaccharides, oligosaccharides and/or monosaccharides. Hydrolyzed starches typically include acid modified starches, acid thinned starches, thin boiling starches, dextrins and maltodextrins. The lightly hydrolyzed starches suitable for the present disclosure typically have a degree of polymerization (DP) of at least about 10.

The term “degree of polymerization” (DP) as used herein, unless otherwise specified, refers to the number of glucose units joined in the molecule. The higher the DP average, the lesser the extent of starch hydrolysis. As the starch is further hydrolyzed, the average molecular weight decreases, the average DP decreases and the carbohydrate profile changes accordingly. Maltodextrins have a greater DP than corn syrup solids.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

All numerical ranges as used herein, whether or not expressly preceded by the term “about”, are intended and understood to be preceded by that term, unless otherwise specified.

The nutritional compositions and methods described herein may also be free of any optional or other ingredient or feature also described herein provided that the remaining compositions or methods still contain the requisite ingredients or features as described herein. In this context, the term “free” means the selected composition or method contains or is directed to less than a functional amount of the ingredient or feature, which most typically is less than 1%, including less than 0.5%, including less than 0.1%, and also including zero percent, by weight of such ingredient or feature.

Any reference to singular characteristics or limitations of the present disclosure shall include the corresponding plural characteristic or limitation, and vice versa, unless otherwise specified or clearly implied to the contrary by the context in which the reference is made.

Any combination of method or process steps as used herein may be performed in any order, unless otherwise specifically or clearly implied to the contrary by the context in which the referenced combination is made.

The nutritional compositions and methods may comprise, consist of, or consist essentially of the elements and features of the disclosure described herein, as well as any additional or optional ingredients, components, or features described herein or otherwise useful in a nutritional application.

### Product Form

The nutritional compositions of the present disclosure may be formulated in any known or otherwise suitable product form for oral administration. The present disclosure is most typically directed to nutritional liquids including both concentrated and ready-to-feed nutritional liquids, although the liquid nutritional composition may be formulated through reconstitution of a powdered, granulated, or dryblended nutritional solid with an aqueous solution, typically water, tea, or another liquid. Although the liquid form is not critical to the present disclosure, these nutritional liquids are most typically formulated as suspensions, emulsions or clear or substantially clear liquids. In many embodiments, the liquid nutritional composition will be a meal replacement product or liquid nutritional supplement.

The nutritional liquids may be and typically are shelf stable. The nutritional liquids typically contain up to about 95% by weight of water, including from about 50% to about 95%, also including from about 60% to about 90%, and also including from about 70% to about 85%, of water by weight of the nutritional liquid.

These nutritional liquids may have a variety of product densities, but most typically have a density greater than about 1.01 g/ml, including from about 1.06 g/ml to about 1.12 g/ml, and also including from about 1.085 g/ml to about 1.10 g/ml.

The nutritional liquid may have a pH ranging from about 2.5 to about 8, but are most advantageously in a range of from about 4.5 to about 7.5, including from about 5.5 to about 7.3, and including from about 6.2 to about 7.2.

The nutritional products also may contain sufficient ingredients to provide up to about 100 kcal per serving, including from 5 kcal to about 90 kcal per serving, and also including from about 10 kcal to about 70 kcal per serving.

### Soluble Viscous Fiber

The nutritional compositions comprise a soluble viscous fiber, sometimes referred to as a water-soluble viscous fiber. In some embodiments, the soluble viscous fiber is used in combination with a soluble carbohydrate to form an induced viscosity fiber (IVF) system as described below.

Exemplary soluble viscous fiber sources included gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactins, glucomannan, xanthan gum, alginate, pectin, low and high methoxy pectin, cereal beta-glucans (i.e., oat beta-glucan, barley beta-glucan), carrageenan and psyllium.

Preferably, the soluble viscous fibers are neutral in charge. Charged polymers are typically more soluble than neutral polymers, thus, neutral polymers are more preferred for use in the nutritional compositions of the present disclosure. Representative of neutral soluble viscous fiber sources are guar gum, pectin, locust bean gum, methylcellulose, cereal beta-glucans (i.e., oat beta-glucan, barley beta-glucan), glucomannan, and konjac flour.

One particularly preferred neutral soluble viscous fiber for use in the nutritional compositions is guar gum. Guar gum is a neutral polysaccharide derived from a leguminous plant, in which alpha-D-galactose is linked, as a side chain, by a 1,6 linkage to the main chain backbone of beta-1,4-D-mannan. The ratio of mannose and galactose in guar gum is about 2:1. The side chain content of guar gum is higher than those of other industrially produced galactomannans (tara gum and locust bean gum). Any source of the guar gum that is known or otherwise suitable for use in an oral nutritional product is also suitable for use herein, provided that such a source is also compatible with, or is otherwise rendered to be compatible with, the other selected ingredients in the composition. Examples of commercially available guar gum products include Sunfibre® manufactured by Taiyo Kagaku Co. (Yokkaichi, Japan), and VIS-TOP™ D-20 and VIS-TOP™ D-2029 manufactured by San-Ei Gen F.F.I., Inc. (New York, N.Y.). Additional commercially available guar gum products are available from TIC Gums, Inc. (Belcamp, Md.).

Another particularly suitable soluble viscous fiber for use in the nutritional compositions is cereal beta-glucan, including oat beta-glucan and barley beta-glucan. Any source of the cereal beta-glucan that is known or otherwise suitable for use in an oral nutritional product is also suitable for use herein, provided that such a source is also compatible with, or is otherwise rendered to be compatible with, the other selected ingredients in the composition.

The cereal beta-glucan suitable for use herein is sourced from grains as opposed to and as distinguished from yeast and mushroom-derived beta-glucan. Cereal beta-glucans are linear chains of β-D-glycopyranosyl units (1-3, 1-4-β-D-linked as compared to yeast-based beta-glucans that are 1-3, 1-6-β-D-linked) in which 70% of the units are typically linked, but which also consist of β-D-cellotriosyl and β-D-cellotetraosyl residues separated by linkages arranged in a random manner. The soluble nature of beta-glucans, in conjunction with their chemical structure, helps to increase the viscosity of foods that contain them.

Suitable cereal-based beta-glucans for use in the nutritional compositions of the present disclosure include oat-derived beta-glucans, barley-derived beta-glucans, and combinations thereof, with barley-derived beta-glucans being especially suitable.

The beta-glucan source for use in the nutritional composition may comprise up to 100% by weight of a beta-glucan, including from about 30% to 100%, and also including from about 50% to 100%, and also including from about 50% to about 95%, and also including from about 60% to about 85%, beta glucan by weight of the beta-glucan source.

The cereal beta-glucan selected for use herein may have any weight average molecular weight suitable for the selected use and formulation, but will most typically range from about 50 kDa to about 1000 kDa, including less than about 750 kDa, including from about 100 kDa to about 250 kDa.

One suitable commercially available source of a barley beta-glucan for inclusion in the nutritional composition is Barliv™ (70% barley beta-glucan), commercially available from Cargill (Panora, Iowa).

The soluble viscous fiber is generally present in the nutritional compositions in an amount of from about 5% to about 90%, including from about 10% to about 50%, also including from about 11% to about 46%, and also including from about 11% to about 25% soluble viscous fiber by weight of the nutritional composition.

### Polyphenol-Containing Plant Extract

The nutritional compositions further comprise a polyphenol-containing plant extract that slows or prevents the digestion of starches and/or sugars. When introduced into an aqueous nutritional composition including a soluble viscous fiber at room temperature, the polyphenol-containing plant extract can also increase the viscosity of the nutritional composition as much as five times as compared to the composition without plant extract. By varying and controlling the amount of plant extract introduced into the nutritional composition, the resulting viscosity can be controlled and adjusted. Typically, the viscosity of a nutritional composition including the combination of a soluble viscous fiber and a polyphenol-containing plant extract is at least about 0.001 Pa·s, including at least about 0.02 Pa·s, including at least about 0.1 Pa·s, including from about 0.01 Pa·s to about 0.03 Pa·s, and including from about 1 Pa·s to about 10 Pa·s.

Additionally, the addition of a polyphenol-containing plant extract can be used to decrease the viscosity of a nutritional composition. In this embodiment, a nutritional composition including the soluble viscous fiber and polyphenol-containing plant extract can be made at room temperature (about 25° C.) and subsequently frozen and thawed prior to use. The polyphenol-containing plant extract thins the thawed composition as compared to an embodiment where the polyphenol-containing plant extract is not present in the nutritional composition.

Additionally, the addition of a polyphenol-containing plant extract solution that has been previously frozen and thawed can be used to decrease the viscosity of a nutritional composition. In this embodiment, a nutritional composition including the soluble viscous fiber can be combined with a solution of a polyphenol-containing plant extract that has been previously frozen and thawed to thin the nutritional composition compared to compositions where the polyphenol-containing plant extract has not been frozen and thawed before adding to the nutritional composition.

The polyphenol-containing plant extract comprises at least about 5%, or at least about 10%, or at least about 15%, or at least 20%, or at least about 25%, or at least about 30%, or at least about 40%, or at least about 50%, or at least about 60%, or at least about 70%, or at least about 80%, or at least about 90% or even 100%, including from about 5% to 100%, including from about 10% to 100%, including from about 25% to 100%, including from about 50% to 100% and further including from about 75% to 100% by weight polyphenolic compounds.

Suitable sources of the polyphenol-containing plant extract include Salacia extract, mixed berry extract, grape pomace extract, prune extract, green tea polyphenols, Morus alba extract, and combinations thereof.

Any source of the polyphenol-containing plant extract that is known or otherwise suitable for use in an oral nutritional product is also suitable for use herein, provided that such a source is also compatible with, or is otherwise rendered to be compatible with, the other selected ingredients in the composition.

The Salacia extract suitable for use herein may include a Salacia oblonga extract and or a Salacia reticula extract, either of which contains at least one of the alpha-glucosidase inhibitors salacinol, kotalanol and mangiferin, which have been shown to inhibit the activity of intestinal alpha-glucosidases and mitigate blood glucose responses upon ingestion of food.

Suitable Salacia oblonga extracts for use in the nutritional compositions include both powdered and liquid forms of Salacia oblonga extracts. One specific example of a suitable Salacia oblonga extract is Salacia oblonga Extract A or Salacia oblonga Extract D (both powdered forms), commercially available from Tanabe Seiyaku Company Limited (Osaka Japan).

The amount of the polyphenol-containing plant extract to be included with the soluble viscous fiber in the nutritional composition may be generally determined depending on the desired end viscosity of the nutritional composition. The nutritional compositions most typically, however, include from about 0.5% to about 50%, including from about 1% to about 40%, also including from about 1% to about 30%, and including from about 1% to about 20%, and including from about 1% to about 10%, and including from about 1% to about 5%, and including from about 1% to about 4% polyphenol-containing plant extract by weight of the nutritional composition.

The nutritional compositions most typically comprise the polyphenol-containing plant extract in amounts ranging from at least about 0.005 milligrams, including from about 0.01 milligrams to about 10 milligrams, and also including from about 0.1 milligrams to about 8.0 milligrams, also including from about 1.0 milligrams to about 5.0 milligrams, and also including about 2.5 milligrams of the extract per milliliter of the nutritional composition.

When used in powdered nutritional compositions, the nutritional compositions most typically comprise the polyphenol-containing plant extract in amounts ranging from at least about 0.05 grams, including from about 0.1 grams to about 1.0 grams, and also including from about 0.1 grams to about 0.4 grams, also including from about 0.1 grams to about 0.5 grams, also including from about 0.1 grams to about 0.25 grams, and also including about 0.24 grams of the extract per serving of the nutritional composition.

### Soluble Carbohydrate/Induced Viscosity System

The nutritional compositions may optionally comprise a soluble carbohydrate in combination with the soluble viscous fiber to form an induced viscosity system. In some embodiments, the soluble carbohydrate is more soluble in water than the water-soluble fiber described above.

Generally, the soluble carbohydrate is a lightly hydrolyzed starch. Representative of suitable starch sources are cornstarch, potato starch, beet starch, rice starch, tapioca starch, and wheat starch and combinations thereof. Numerous commercial sources of starch and hydrolyzed starch are readily available and known to one practicing the art. For example, maltodextrin, glucose polymers, and hydrolyzed cornstarch are available from Cerestar (Hammond, Ind.). Wheat, rice and cornstarches are available from Weetabix Company (Clinton, Mass.). Potato starch is available from Staley Mfg. Company (Decatur, Ill.).

Alternatively, hydrolyzed starch may be obtained by acid, enzyme or combined hydrolysis of starch. One practicing the art would be aware of suitable hydrolysis methods. Typically, acid modified starches are made by mild acid hydrolysis of starch. For example, granular starch is suspended in very dilute acid and held at a temperature below its gelatinization temperature to yield an acid modified or thin boiling starch. Maltodextrins are typically prepared by partial hydrolysis of cornstarch with acids and enzymes. Dextrins are typically prepared by a process called pyrolysis, which involves a dry reaction with heat and acid.

One particularly preferred lightly hydrolyzed starch for use with the water-soluble fiber is maltodextrin. Exemplary commercially available maltodextrin products include Maltrin® (Grain Processing Corporation, Muscatine, Iowa) and Fibersol 2™ (Archer Daniels Midland Company, Bloomington, Ill.).

Upon digestion of the nutritional composition, the IVF system is exposed to α-amylase, which begins to digest the soluble carbohydrate, enabling the water-soluble fiber to become solubilized. The IVF system of the nutritional composition generates a viscous digesta resulting in the slow release of nutrients into the small intestine. The slow release of nutrients into the small intestine results in prolonged absorption of nutrients, thereby blunting the glycemic response to the meal, which may be advantageous to diabetics and others with glucose tolerance issues.

The nutritional compositions typically include an amount of IVF system of from about 5% to about 99%, including from about 10% to about 90%, including from about 10% to about 75%, including from about 10% to about 50%, including from about 10% to about 40% by weight of the nutritional composition.

In some embodiments, the nutritional compositions may include at least about 0.05 milligrams of IVF system, including from about 0.05 milligrams to about 20 milligrams, also including from about 1.0 milligrams to about 15 milligrams, also including from about 5.0 milligrams to about 10 milligrams, and also including about 7.5 milligrams of IVF system per milliliter of the nutritional composition.

In powdered embodiments, the nutritional compositions may include at least about 0.5 grams, including from about 0.5 grams to about 4 grams, also including from about 0.7 grams to about 2.0 grams, and also including about 0.75 grams, of IVF system per serving of the nutritional composition.

The IVF system will generally include a weight ratio of water soluble fiber to soluble carbohydrate of from about 1:0.5 to about 1:5.0.

### Filler Material

In addition to the ingredients discussed above, the nutritional compositions described herein may further optionally comprise a filler material to further augment the bulk properties of the nutritional compositions. These filler materials may include any such material suitably known for or otherwise suitable for use in a nutritional composition.

The filler material may include any nutritional ingredient that adds bulk to the composition, and in most instances will be substantially inert, and does not significantly negate the blood glucose benefits of the nutritional composition. The filler material most typically includes a fiber, other than the water-soluble fibers discussed above, and or carbohydrate having a low glycemic index, although it is understood that other non-carbohydrate fillers as well as high glycemic index carbohydrate fillers may be used, although less desirably.

The filler material, including any carbohydrate or fiber filler material, may represent enough of the finished product to provide the desired bulk or flow properties, but most typically represents from about 30% to about 90%, including from about 40% to about 85%, also including from about 50% to about 85%, and also including from about 75% to about 80%, by weight of the nutritional composition.

Any carbohydrate source suitable for use in a nutritional composition is also suitable for use as a filler material in the nutritional compositions described herein. Such carbohydrates, however, may advantageously include those having a low glycemic index such as fructose. Other suitable carbohydrate filler material includes any dietary fiber suitable for use in a nutritional product, including insoluble fiber, especially fructooligosaccharides. The filler material may be selected such that it does not negatively impact the function of the IVF system, and optionally, the synergistic nature of the IVF system and Salacia extract combination described herein.

Non-limiting examples of commercially available additional filler materials for use herein include Nutriose® (Roquette Freres, France), which is a resistant wheat dextrin starch/fiber having extended energy release and typically is used as a sugar substitute.

### Optional Ingredients

The nutritional composition of the present disclosure may further comprise other optional ingredients that may modify the physical, chemical, aesthetic or processing characteristics of the compositions. Many such optional ingredients are known or otherwise suitable for use in nutritional products and may also be used in the nutritional compositions described herein, provided that such optional ingredients are safe and effective for administration and are compatible with the essential and other selected components in the compositions.

In some embodiments, the nutritional compositions may include a fat source, a protein source, a flowing agent, a stabilizer, a preservative, an anti-oxidant, an acid, a buffer, a pharmaceutical active, a sweetener, an intense sweetener, a colorant, a flavor, a flavor enhancer, an emulsifying agent, an anti-caking agent, a lubricant, and so forth, as well as any combination thereof. Although it is within the scope of the present disclosure for the nutritional composition to include a fat source and/or a protein source, it is generally preferred that the nutritional composition be fat free and/or protein free. When included, the fat and/or protein source may be any conventional fat or protein source suitable for use in powdered nutritional compositions.

A flowing agent or anti-caking agent may be included in the nutritional compositions as described herein to retard clumping or caking of the powder over time and to make a powder embodiment flow easily from its container. Any known flowing or anti-caking agents that are known or otherwise suitable for use in a nutritional powder or product form are suitable for use herein, non-limiting examples of which include tricalcium phosphate, silicates, and combinations thereof. The concentration of the flowing agent or anti-caking agent in the nutritional composition varies depending upon the product form, the other selected ingredients, the desired flow properties, and so forth, but most typically range from about 0.1% to about 4%, including from about 0.5% to about 2%, by weight of the nutritional composition.

A stabilizer may also be included in the nutritional compositions. Any stabilizer that is known or otherwise suitable for use in a nutritional product is also suitable for use herein, some non-limiting examples of which include gums such as xanthan gum. The stabilizer may represent from about 0.1% to about 5.0%, including from about 0.5% to about 3%, including from about 0.7% to about 1.5%, by weight of the nutritional composition.

The nutritional compositions may further comprise minerals suitable for use in a nutritional product, non-limiting examples of which include phosphorus, sodium, chloride, magnesium, manganese, iron, copper, zinc, iodine, calcium, potassium, chromium, chromium picolinate, molybdenum, selenium, and combinations thereof. Chromium picolinate is particularly useful in the nutritional compositions.

The nutritional composition may further comprise any vitamins or similar other materials suitable for use in a nutritional product, some non-limiting examples of which include carotenoids (e.g., beta-carotene, zeaxanthin, lutein, lycopene), biotin, choline, inositol, folic acid, pantothenic acid, vitamin A, thiamine (vitamin B1), riboflavin (vitamin B2), niacin (vitamin B3), pyridoxine (vitamin B6), cyanocobalamin (vitamin B12), ascorbic acid (vitamin C), vitamin D, vitamin E, vitamin K, and various salts, esters or other derivatives thereof, and combinations thereof. Vitamin C, vitamin D, and or vitamin B12 are particularly useful in the nutritional composition.

### Manufacture

The nutritional liquid compositions may be manufactured by any known or otherwise suitable method for making nutritional liquids, including emulsions such as milk-based nutritional emulsions.

In one suitable manufacturing process, a nutritional liquid composition is prepared using at least a carbohydrate-mineral (CHO-MIN) slurry, and if the composition includes protein and or fat, a protein-in-fat (PIF) slurry and a protein-in-water (PIW) slurry. The CHO-MIN slurry is formed by adding with heated agitation to water: minerals (e.g., potassium citrate, dipotassium phosphate, sodium citrate, etc.), trace and ultra trace minerals (TM/UTM premix), thickening or suspending agents (e.g. Avicel, gellan, carrageenan), water-soluble fiber, and, optionally, a Salacia extract. The resulting CHO-MIN slurry is held for 10 minutes with continued heat and agitation before adding additional minerals (e.g., potassium chloride, magnesium carbonate, potassium iodide, etc.) and/or carbohydrates (e.g., fructooligosaccharide, sucrose, corn syrup, etc.). The PIF slurry is formed by heating and mixing the selected oils (e.g., canola oil, corn oil, fish oil, etc.) and then adding an emulsifier (e.g., lecithin), fat soluble vitamins, and a portion of the total protein (e.g., milk protein concentrate, etc.) with continued heat and agitation. The PIW slurry is then formed by mixing with heat and agitation the remaining protein (e.g., sodium caseinate, soy protein concentrate, etc.) into water.

The resulting slurries are then blended together with heated agitation and the pH adjusted to the desired range, typically from 6.6-7.0, after which the composition is subjected to high-temperature short-time (HTST) processing during which the composition is heat treated, emulsified and homogenized, and then allowed to cool. Water soluble vitamins and ascorbic acid are added, the pH is again adjusted to the desired range if necessary, flavors are added, and water is added to achieve the desired total solid level. The composition is then aseptically packaged to form an aseptically packaged nutritional liquid, or the composition is added to retort stable containers and then subjected to retort sterilization to form retort sterilized nutritional liquids.

Alternatively, the nutritional compositions may be prepared as a powder by any known or otherwise effective manufacturing technique for preparing the powder. Many such techniques are known and may be applied by one of ordinary skill in the art to the nutritional compositions described herein.

One particularly desirable manufacturing method includes the dry blending of the selected ingredients to form a dry blended powder. In this process, for example, the IVF system, Salacia extract, and any other optional materials, each in dry form, are combined as such and thoroughly mixed in a suitable mixing apparatus to form a dry blended nutritional composition in powder form. The resulting dry blended composition may then be packaged in any desired size and material suitable for containing nutritional compositions in powder form.

While the addition of the Salacia extract to the nutritional composition increases the viscosity of the nutritional composition as discussed above, the viscosity of the nutritional composition including an IVF system can further be adjusted or controlled by adjusting the manufacturing conditions (i.e., temperature) when making the nutritional composition. This allows for an alternative means of controlling the viscosity of the nutritional composition without adjusting the concentration of water-soluble fiber in the IVF system of the composition, and potentially compromising the blood glucose lowering effect of the IVF system. For example, while described above as increasing the viscosity of a nutritional composition, the addition of a Salacia extract to a freeze-thawed composition has been found to reduce the viscosity of the freeze-thawed composition by three times or greater.

In addition, freezing and thawing the solution of Salacia oblonga extract before adding to the viscous fiber thins the solution by up to 93% compared to solutions that do not contain previously frozen and thawed solutions of Salacia oblonga extract.

Accordingly, by adjusting the conditions of the manufacturing methods using one or more of the above described embodiments, and/or including additional components such as Salacia extract in the nutritional compositions including an IVF system, the viscosity of the nutritional compositions can be adjusted or controlled as desired to produce a nutritional composition that has improved palatability to the consumer.

The manufacturing processes for the nutritional compositions may be carried out in ways other than those set forth herein without departing from the spirit and scope of the present disclosure. The present embodiments are, therefore, to be considered in all respects illustrative and not restrictive and that all changes and equivalents also come within the description of the present disclosure.

### Methods of Use

The nutritional compositions may be used in accordance with the methods of the present disclosure, wherein such methods comprise the oral administration of the nutritional compositions described herein to individuals in need of blood glucose control, especially for modulating the blood glucose response during and or after a meal, including a carbohydrate-containing meal.

In accordance with the methods described herein, the term blood glucose control means a delay in the peak blood glucose response following a meal, a reduced blood glucose peak level following a meal, and/or a reduced blood glucose AUC following a meal.

The methods are especially useful in individuals afflicted with prediabetes, individuals afflicted with type 2 diabetes, overweight or obese individuals, individuals with impaired glucose tolerance, individuals at risk for developing diabetes, or other individuals who may otherwise benefit from the blood glucose control benefits made possible by the methods and compositions described herein.

In accordance with the methods described herein, the nutritional compositions may be administered to or orally consumed by an individual before, during, or after a meal to control blood glucose levels as defined herein.

In one embodiment of the methods described herein, the nutritional product is in liquid form to be orally consumed by an individual before, during, or after a meal. Alternatively, the nutritional product is in powder form either to be reconstituted with an aqueous liquid or sprinkled on food before it is consumed such that the nutritional composition in powder form is ingested during the meal.

The nutritional compositions may be administered to or consumed by the individual with one or more carbohydrate-containing or other meals per day, and or may be administered to or consumed by the individual once daily, twice daily, three times a day, four times a day or even more times per day to provide the desired blood glucose control in the individual. The nutritional composition may be administered to or consumed by the individual within 0 to 60 minutes of the meal, including within 1 to 30 minutes of the meal, and including during the meal.

### EXAMPLES

The following Examples illustrate specific embodiments and or features of the nutritional compositions and methods of the present disclosure. The Examples are given solely for the purpose of illustration and are not to be construed as limitations, as many variations thereof are possible without departing from the spirit and scope of the disclosure.

### Example 1

In this Example, the effect of various water-soluble dietary fibers (Sunfibre®, Nutriose®, WPG™ Yeast Beta Glucan and Barliv™), alone or in combination with Salacinol (Salacia oblonga extract D), on postprandial glucose levels at 30 minutes are analyzed. Pre-diabetic (obese rats) and diabetic animal models are evaluated.

Postprandial blood glucose levels are evaluated in the prediabetic (obese) and diabetic Zucker male rats and in diabetic male mice at the age of approximately 6-8 weeks. Initially, the body weights of the animals are recorded before fasting and basal blood glucose measurements are taken. The animals fast overnight and are then randomized based on their basal glucose levels and assigned into different experimental groups (n=5 to 7 per group).

Various sample compositions of water-soluble fibers and/or Salacinol are prepared. To formulate the sample compositions, a corn starch suspension is first prepared by mixing 1 gram of corn starch with 10 ml of 0.5% Tween-80 in distilled water. The water-soluble fiber and or Salacinol are then slowly added to and mixed with the corn starch suspension at the concentrations described in the following table.

| Sample | Sun- | | | | |
|---|---|---|---|---|---|
| (mg/Kg) | fibre ® | Nutriose ® | Barliv ™ | WPG ™ | Salacinol |
| 1 | 600 | — | — | | — |
| 2 | 600 | — | — | | 12.5 |
| 3 | 1000 | — | — | | — |
| 4 | 1000 | — | — | | 12.5 |
| 5 | — | 100 | — | | — |
| 6 | — | 100 | — | | 6.25 |
| 7 | — | — | 100 | | — |
| 8 | — | — | 100 | | 6.25 |
| 9 | — | — | 200 | | — |
| 10 | — | — | 200 | | 12.5 |
| 11 | — | — | — | | 6.25 |
| 12 | — | — | — | | 12.5 |
| 13 | — | — | — | — | 6.25 |
| 14 | — | — | — | 100 | 6.25 |

The compositions summarized above in the table are administered to the animals (where mg/kg of sample refers to mg of fiber or Salacinol per kg of body weight of the animals) as a single oral dose (10 ml/Kg body weight) to the animals. After 30 minutes, the blood-glucose levels of the animals are tested using a glucometer and test strips (One Touch Ultra Lifescan, available from Johnson & Johnson, San Jose, Calif.). The tail of each animal is wiped clean with absorbent cotton and a drop of blood is obtained from the tip. Each sample of blood is placed on a sampling area of the glucometer strip.

Results are expressed as means±SEM as percent change in glucose (mg/dl). Statistical analysis is performed by t-test for blood glucose levels. The results are shown in the following table.

| | | Diabetic | | | | Diabetic | | Diabetic |
|---|---|---|---|---|---|---|---|---|
| | Obese Rat | Rat | Obese Rat | Obese Rat | Diabetic Rat | Rat | Obese Rat | Mouse |
| | Dosage (mg/Kg) | | | | | | | |
| | Sunfiber ® | Sunfiber ® | Nutriose ® | Barliv ™ | Barliv ™ | WPG ™ | Barliv ™ | Barliv ™ |
| | 600 | 1000 | 100 | 100 | 100 | 100 | 200 | 200 |
| | Saliconol | Saliconol | Salacinol | Salacinol | Salacinol | Salacinol | Salacinol | Salacinol |
| | 12.5 | 12.5 | 6.25 | 6.25 | 6.25 | 6.25 | 12.5 | 12.5 |
| Sunfibre ® | 27.4 | 37.5 | — | — | — | — | — | — |
| Nutriose ® | — | — | −1.80 | — | — | — | — | — |
| Barliv ™ | — | — | — | −6.1 | 1.3 | — | 2.7 | −17.5 |
| WPG ™ | — | — | — | — | — | −4.87 | — | — |
| Salacinol | −51.1 | −59.5 | −22.75 | −9.8 | 3.8 | −10.12 | −12.2 | −11.1 |
| Sunfibre ® + Salacinol | −27.1 | −27.5 | — | — | — | — | — | — |
| Nutriose ® + Salacinol | — | — | −19.41 | — | — | — | — | — |
| Barliv ™ + Salacinol | — | — | — | −27.6 | −11.3 | — | −21.2 | −70.4 |
| WPG ™ + Salacinol | — | — | — | — | — | −9.55 | — | — |
| Observed Effect | Inhibition | Inhibition | No synergy | Synergy | Synergy | No synergy | Synergy | Synergy |

In the diabetic rat, obese rat, and diabetic mouse models, the combination of Barliv™ and Salacinol at varied concentrations shows significant synergistic activity in reducing postprandial glucose levels at 30 minutes. Sunfibre® shows significant inhibition of Salacinol activity on postprandial levels at all concentrations tested. Nutriose®, alone or in combination with Salacinol, does not show a significant effect on postprandial glucose levels. Additionally, the yeast derived beta glucan (WPG™ Beta Glucan) in combination with the Salacinol showed a neutral, non-synergistic effect.

Based on these animal study results, the combination of Barliv™ (a cereal-based beta glucan) and Salacinol produces a synergistic effect on postprandial glucose levels as compared to an inhibitory effect or no effect at all for the other fibers in combination with Salacinol.

### Example 2

In this Example, blood glucose lowering effects of barley-derived beta glucan (Barliv™) and yeast-derived beta glucan (WGP™) in pre-diabetic (obese) and diabetic animal models are compared. The effects are evaluated at postprandial time points of 30 minutes, 60 minutes, 90 minutes, and 120 minutes.

The effect on postprandial blood glucose levels is evaluated in obese and diabetic Zucker male rats and in diabetic male mice at the age of approximately 6-8 weeks. Initially, the body weights of the animals are recorded before fasting and before basal glucose measurements. The animals fast overnight and are then randomized based on their basal glucose level and assigned into 3 different experimental groups (n=9 per group).

A corn starch suspension is prepared by mixing 1 gram of corn starch with 10 ml of 0.5% Tween-80 in distilled water. This corn starch suspension is administered to the control group. A second suspension is prepared using the corn starch suspension prepared in the control group and slowly mixing Barliv™ (100 mg/Kg) therein. Additionally, a third suspension is prepared by slowly mixing the corn starch suspension of the control group with yeast whole beta-glucan particle (WGP™) (100 mg/Kg).

The compositions are administered to their respective experimental group at a single oral dosage (10 ml/Kg body weight) to the animals. After 30 minutes, 60 minutes, 90 minutes, and 120 minutes, the blood-glucose levels of the animals are tested using a glucometer and test strips (One Touch Ultra Lifescan, available from Johnson & Johnson). The tail of each animal is wiped clean with absorbent cotton and a drop of blood is obtained from the tip and placed on the sampling area of the glucometer strip.

Results are expressed as % change in AUC±SEM. Statistical analysis is performed by t-test for blood glucose levels and one-way ANOVA followed by Dunnett's multiple comparison for AUC using graph pad prism software (significance at P<0.05). The AUC (0-120 min) values expressed as percent change in blood glucose level are shown in the following table.

| | % change in AUC (0-120 min) |
|---|---|
| Cornstarch Control Group | 0 |
| Barliv ™ Group | −18.1% |
| WCP ™ Group | 3.9% |

The administration of Barliv™ with the corn starch solution shows a significant glucose lowering effect in the mice as compared to the administration of WGP™ in the same animal model. The data further shows that WGP™ does not lower blood glucose levels at all.

### Example 3

In this Example, the viscosities of compositions including an IVF system, with and without the addition of a Salacia extract, are analyzed.

A composition including an IVF system (IVF) is prepared by mixing an IVF system including guar gum and maltodextrin (in a weight ratio of 1:0.5) with vitamin C, vitamin D, and chromium picolinate in room temperature (25° C.) water. A second composition (IVFSOE) is prepared by first preparing a solution of Salacia oblonga extract D (2.5 mg/ml) in 25° C. water. This solution is used to solubilize the IVF system including guar gum and maltodextrin (in a weight ratio of 1:0.5) with vitamin C, vitamin D, and chromium picolinate. Final concentrations for both IVF and IVFSOE solutions are: IVF, 7.5 mg/ml; vitamin C, 1.88 mg/ml; vitamin D, 0.015 mg/ml; and chromium picolinate, 0.0198 mg/ml.

The viscosities of the solutions are measured on a ARES-LS1 rheometer using 32 mm coquette geometry at 25° C. Measurements are made utilizing a steady rate sweep test to measure shear viscosity as a function of shear rate. More particularly, 16 ml of each composition is independently placed into the coquette and the bob is lowered into the sample with a gap set to 12.45 mm. Each composition is then presheared at 100 s-1 for 200 seconds at 25° C. before being analyzed. The steady rate sweep test is set up on a 300 second delay to allow the composition to recover from the preshear before starting measurement. This recovery time is to ensure that the compositions are treated consistently before being tested. The compositions are then analyzed in a clockwise direction starting at 0.05 s-1 and ending at 300 s-1. The measurement time is 8 seconds with a 5-second delay before the measurement and collected at 10 points per decade. Two runs of each composition are tested.

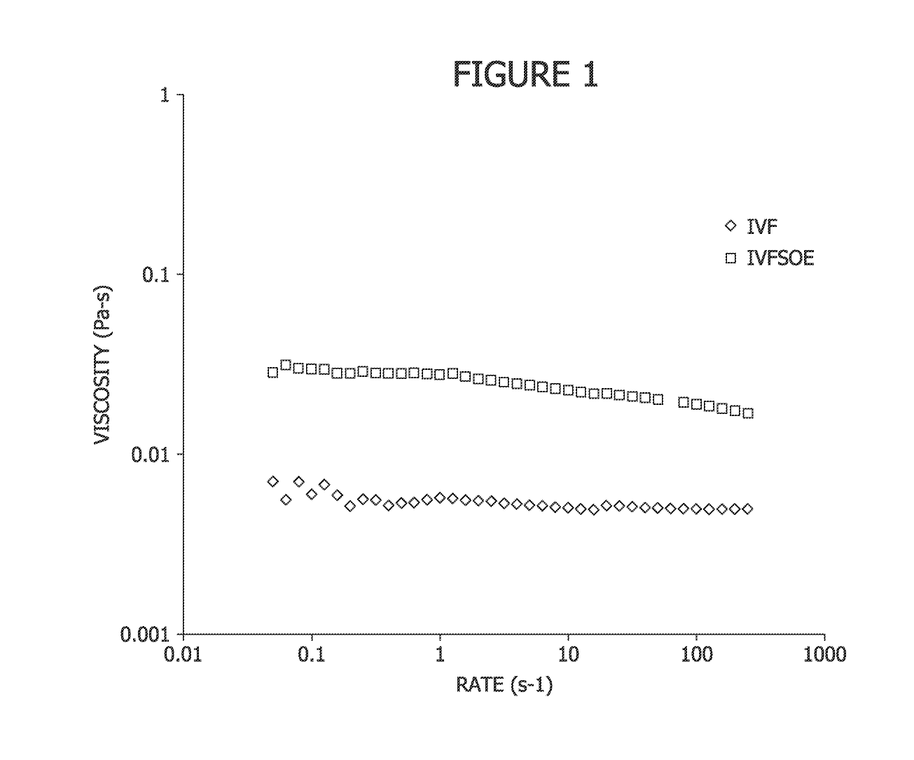

The results of the viscosity measurements are shown in FIG. 1. Specifically, at resting shear, the addition of Salacia oblonga extract to induced viscosity fiber (IVFSOE) increases viscosity by 5.2 times, from 0.005373 to 0.0282 Pa·s. At processing shear, the addition of Salacia oblonga extract to induced viscosity fiber increases the viscosity by about 4.4 times, from 0.005 to 0.0222 Pa·s. The results indicate that Salacia oblonga extract increases the viscosity of a composition comprising viscous fiber.

### Example 4

In this Example, the interaction of Salacia oblonga extract and freeze-thawing on the viscosities of induced viscosity fiber compositions is analyzed.

The IVF and IVFSOE compositions are first prepared as described in Example 3. However, these compositions are each frozen at −20° C. for 16 hours after being prepared. The IVF and IVFSOE compositions are then thawed and the viscosities of both of the compositions are measured as described in Example 3.

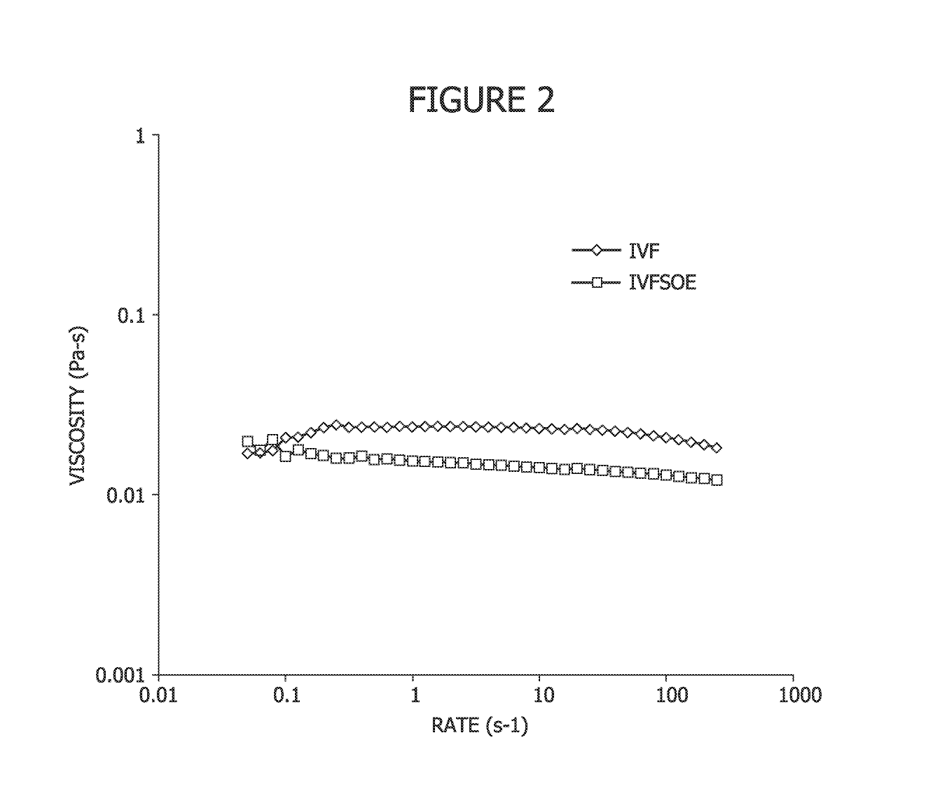

The results of the viscosity measurements are shown in FIG. 2. Specifically, at resting shear, Salacia oblonga extract reduced the viscosity of the IVF composition from 0.239 Pa·s to 0.0157 Pa·s, a 34% decrease. At processing shear, Salacia oblonga extract reduced the viscosity of the IVF composition from 0.0233 to 0.0140 Pa·s, a 40% decrease. The results indicate that Salacia oblonga extract decreases the viscosity of a composition comprising viscous fiber if the composition is frozen and thawed.

### Example 5

In this Example, the effect of pre-freezing the Salacia oblonga extract solution before adding to the viscous fiber is analyzed.

Salacia oblonga extract (2.5 mg/ml) solution is prepared as in Example 3. The Salacia oblonga extract solution is frozen overnight at −20° C. and then thawed. An IVF composition is prepared with water as described in Example 3. An IVFSOE composition is also prepared as in Example 3, with the exception that the composition is prepared with the previously frozen and thawed mixture of Salacia oblonga extract. The viscosities of the IVF and IVFSOE compositions are measured as described in Example 3.

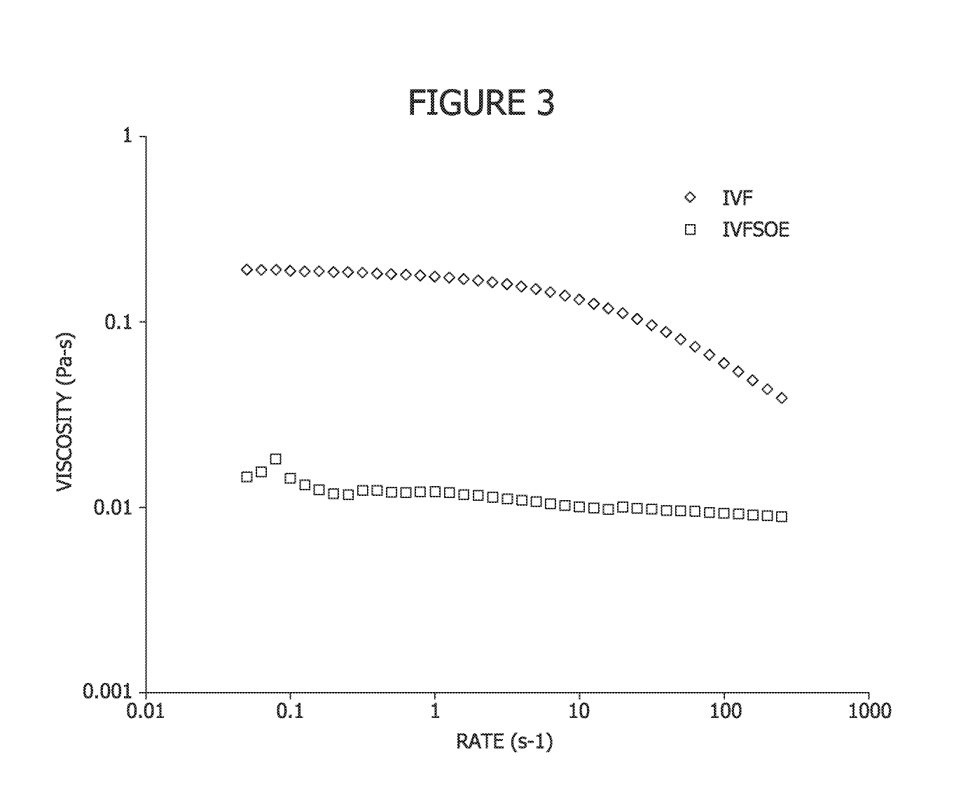

The results of the viscosity measurements are shown in FIG. 3. Specifically, the frozen and the thawed Salacia oblonga extract decreases the viscosities of the viscous fiber compositions from 0.1814 Pa·s to 0.01205 Pa·s, a 93% decrease. The results indicate that the pre-frozen and thawed Salacia oblonga extract is able to decrease the viscosity of a composition of viscous fiber that has never been frozen.

### Example 6

In this Example, the effect of adding a pre-frozen and thawed Salacia oblonga extract solution to a viscous fiber containing only guar gum is analyzed.

Salacia oblonga extract (2.5 mg/ml) solution is prepared as in Example 3. The Salacia oblonga extract solution is frozen overnight at −20° C. and then thawed. A guar gum composition (5 mg/ml) (Guar) is prepared by mixing guar gum with 25° C. water. A guar gum/Salacia oblonga extract composition (GuarSOE) is prepared by mixing guar gum with the previously frozen and thawed solution of Salacia oblonga extract (5 mg guar gum/ml). The viscosities of the Guar composition and the GuarSOE composition are measured as described in Example 3.

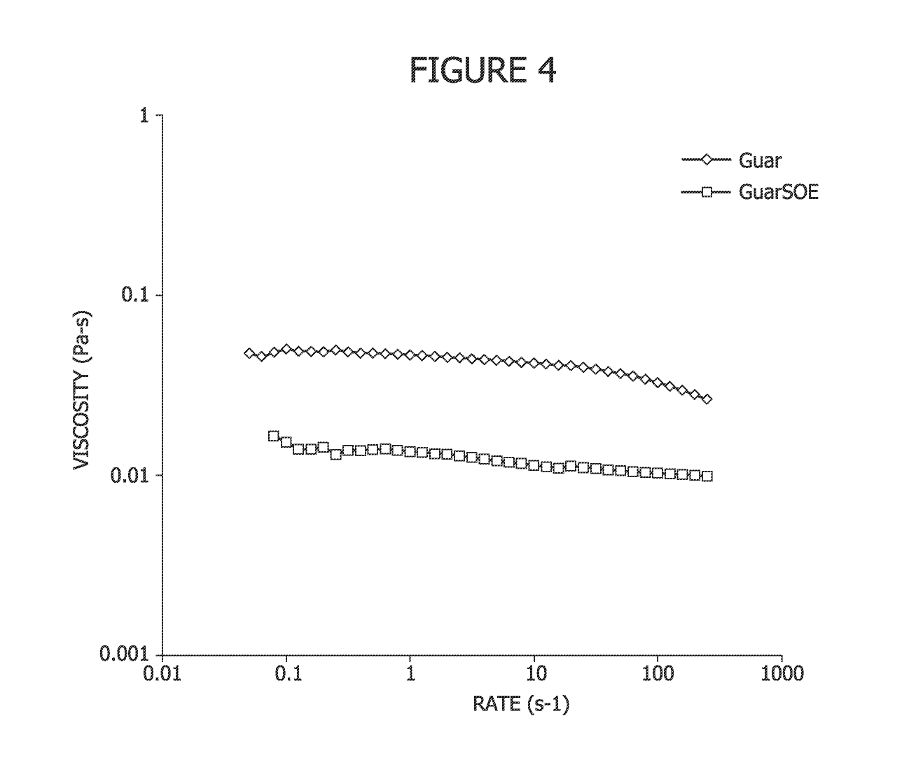

The results of the viscosity measurements are shown in FIG. 4. Specifically, at resting shear, frozen and thawed Salacia oblonga extract decreases the viscosity of the guar gum composition from 0.0477 Pa·s to 0.0139 Pa·s, a 71% decrease. At processing shear, frozen and thawed Salacia oblonga extract decreases the viscosity of the guar gum composition from 0.0414 Pa·s to 0.0112 Pa·s, a 73% decrease. The results indicate that the viscosity decreasing effect of pre-frozen and thawed Salacia oblonga extract applies to a guar gum composition.

### Examples 7-15

Examples 7-15 illustrate selected embodiments of the nutritional compositions of the present disclosure, which embodiments include combinations of Barliv™ and Salacia oblonga extract. The exemplified formulations are described in the table below. The percentage of each ingredient is the weight percent of the ingredient based on the total weight of the nutritional composition, and the number in parentheses (where shown) is the amount, in grams, of the ingredient per serving. Example 15 illustrates a lemon flavored embodiment of the nutritional compositions of the present disclosure, which embodiment includes a combination of Barliv™ and Salacia oblonga extract. Example 15 illustrates a flavored embodiment that provides 2.0 g of Barliv™ and 0.12 g of Salacia per serving.

These powdered nutritional compositions are prepared by dry mixing the ingredients together and/or agglomerating the mixture to have improved mixability. The formulations may be used directly, such as sprinkled directly on food, or may be reconstituted with water or tea prior to use to the desired target ingredient concentrations.

| Ingredient | Example 7 | Example 8 | Example 9 | Example 10 |
|---|---|---|---|---|
| Barliv ™ | 46.22% (1.1) | 11% (1.1) | 20% (2.0) | 22% (1.1) |
| Salacia | 7.56% (0.18) | 1.8% (0.18) | 1.2% (0.12) | 3.6% (0.18) |
| Extract | | | | |
| Nutriose ® | — | 60% (6.0) | 50% (5.0) | 66% (3.3) |
| Agglomerated | 42.02% (1.0) | 10% (1.0) | — | — |
| Maltodextrin | | | | |
| Maltodextrin | — | — | — | 1.33% (0.0667) |
| Fructooligo- | — | 5.2% (0.52) | 16.8% (1.68) | — |
| saccharides | | | | |
| Fructose | — | 10% (1.0) | 10% (1.0) | — |
| Tricalcium | — | 1.0% (0.1) | 1.0% (0.1) | 2.0% (0.1) |
| phosphate | | | | |
| Xanthan gum | 4.2% (0.1) | 1.0% (0.1) | 1.0% (0.1) | 1.4% (0.07) |
| Vitamin C | — | — | — | 3.6% (0.18) |
| Vitamin D | — | — | — | 0.03% (0.0015) |
| Vitamin B12 | — | — | — | Trace |
| Chromium | — | — | — | 0.035% (0.00177) |
| Picolinate | | | | |

| Ingredient | Example 11 | Example 12 | Example 13 | Example 14 |
|---|---|---|---|---|
| Barliv ™ | 46.22% | 11% | 15% | 22% |
| Salacia | 7.56% | 1.8% | 1.2% | 4.6% |
| Extract | | | | |
| Nutriose ® | — | 40% | 50% | 65% |
| Agglomerated | 38.02% | 10% | 10% | — |
| Maltodextrin | | | | |
| Maltodextrin | 2.00% | 20.0% | 5.00% | 1.33% |
| Fructooligo- | — | 5.2% | 6.8% | — |
| saccharides | | | | |
| Fructose | 2.00% | 10% | 10% | — |
| Tricalcium | — | 1.0% | 1.0% | 2.0% |
| phosphate | | | | |
| Xanthan gum | 4.2% | 1.0% | 1.0% | 1.4% |
| Vitamin C | — | — | — | 3.6% |
| Vitamin D | — | — | — | 0.03% |
| Vitamin B12 | — | — | — | Trace |
| Chromium | — | — | — | 0.035% |
| Picolinate | | | | |

| Ingredient | Example 15 |
|---|---|
| Salacia | 1.2 (0.12) |
| Extract | |
| Barliv ™ | 20 (2) |
| Nutriose ® | 50 (5) |
| Fructooligo- | 9.7 (0.97) |
| saccharides | |
| Fructose | 10.0 (1) |
| Lemon Flavor | 4.0 (0.4) |
| Citric Acid | 3.0 (0.3) |
| Tricalcium | 1.0 (0.1) |
| Phosphate | |
| Xanthan Gum | 1.0 (0.1) |
| Sucralose | 0.1 (0.01) |

What is claimed is:

1. A nutritional composition comprising a soluble viscous fiber and a plant extract having a polyphenol content of at least about 10% by weight.

2. The nutritional composition of claim 1 wherein the plant extract has a polyphenol content of at least about 50% by weight.

3. The nutritional composition of claim 1 wherein the soluble viscous fiber is a cereal beta-glucan selected from the group consisting of barley beta-glucan, oat beta glucan, and combinations thereof.

4. The nutritional composition of claim 3 wherein the cereal beta-glucan is barley beta-glucan.

5. The nutritional composition of claim 1 wherein the plant extract is selected from the group consisting of Salacia extract, mixed berry extract, grape pomace extract, prune extract, green tea polyphenols, Morus alba extract, and combinations thereof.

6. The nutritional composition of claim 5 wherein the Salacia extract is selected from the group consisting of Salacia oblonga extract, Salacia reticula extract, and combinations thereof.

7. The nutritional composition of claim 6 wherein the Salacia extract comprises from about 0.5% to about 10% by weight of the nutritional composition.

8. A nutritional composition comprising an induced viscosity fiber system and a plant extract having a polyphenol content of at least about 10% by weight, wherein the induced viscosity fiber system comprises a soluble viscous fiber and a soluble carbohydrate.

9. The nutritional composition of claim 8 wherein the soluble viscous fiber is a cereal beta-glucan selected from the group consisting of barley beta-glucan, oat beta glucan, and combinations thereof.

10. The nutritional composition of claim 9 wherein the cereal beta-glucan is barley beta-glucan.

11. The nutritional composition of claim 8 wherein the soluble carbohydrate is a lightly hydrolyzed starch.

12. The nutritional composition of claim 8 wherein the weight ratio of the water soluble fiber to the soluble carbohydrate is from about 1:0.5 to about 1:5.0.

13. The nutritional composition of claim 8 wherein the plant extract having a polyphenol content of at least about 10% by weight is a Salacia extract selected from the group consisting of Salacia oblonga extract, Salacia reticula extract, and combinations thereof.

14. The nutritional composition of claim 13 wherein the Salacia extract comprises from about 0.5% to about 10% by weight of the nutritional composition.

15. A method of controlling the viscosity of a liquid nutritional composition comprising a soluble viscous fiber, the method comprising:
combining a plant extract having a polyphenol content of at least about 10% by weight with the soluble viscosity fiber in a liquid solution;
freezing the liquid solution; and
thawing the liquid solution to room temperature.
